(19) United States
(12) Patent Application Publication
(10) Pub. No.: US 2004/0070825 A1
(43) Pub. Date: Apr. 15, 2004

(54) Stereoscopic viewing apparatus

(76) Inventor: Nicholas Charlesworth, Whickham (GB)

Correspondence Address: HIGGS, FLETCHER & MACK LLP, 2600 FIRST NATIONAL BANK BUILDING, 401 WEST "A" STREET, SAN DIEGO, CA, 92101-7910, US

(21) Appl. No.: 10/470,118

(22) PCT Filed: Jan. 24, 2002
(86) PCT No.: PCT/GB02/00284

(30) Foreign Application Priority Data
Jan. 24, 2001 (GB) 0101791.2

(51) Int. Cl. G02B 27/22

(52) U.S. Cl. 359/462

(57) ABSTRACT

A pair of spectacles adapted for viewing stereoscopic images is disclosed. In accordance with the invention, within the body of the spectacles, there is provided a pair of mirror assemblies each of which has a pair of substantially parallel mirrors arranged in periscope-type manner so that light is shifted laterally between the mirrors. The spectacles include an adjustment mechanism which simultaneously adjusts one of the mirrors in each assembly by an identical amount, but in the opposite direction so that the two pairs of images seen by the wearer become superimposed, whereupon the wearer immediately perceives a stereo or 3D image in the region where he perceives the superimposition to occur. Means are also provided to allow the separation of left and right casings (10, 12), each housing one of the mirror assemblies and one set of apertures, ti be adjusted. This allows the interocular spacing to be varied.

This invention relates to stereoscopic viewing apparatus, and more particularly to stereoscopic viewing apparatus for use by individuals and either worn thereby or provided with a means of positioning said apparatus immediately in front of the eyes of a user to ensure that the stereoscopic effect is achieved repeatably and as simply as possible.

Stereoscopic viewing of images is already a well known art, and indeed apparatus for viewing adjacently positioned stereoscopic image pairs' has been considered in the past. Many different types of stereoscopic images have heretofore been developed, but in general all such images depend on the capacity of the human brain together with the separation of the eyes to view such images separately. More specifically, a pair of images of an object or scene, such as a pair of photographs which are taken from different positions slightly displaced relative to one another may be adjacently positioned and viewed stereoscopically by a human even without the need for complex viewing apparatus.

The stereoscopic effect is achieved by deceiving the brain into believing that only a single image really exists, and this can be achieved by using stereoscopic viewing spectacles which constrain each of the eyes to focus on only one of the images. The brain is deceived into believing that only a single image really exists and the ultimate effect is to give the impression to a human that the apparent single image has an element of depth or is effectively in three dimensions.

Many different techniques are available for achieving this deception. One technique used in cartography involves aerial photography wherein a landscape is photographed from two closely spaced locations in the air and the resulting pictures are juxtaposed on a viewing surface beneath a pair of stereoscopic viewing spectacles in which a pair of magnifying lenses are providing. The user views the two images through the spectacles and after forcing himself to de-focus the eyes slightly, the three dimensional effect becomes suddenly apparent and the relative depth of various structures in the photographs becomes visible.

Additionally, computers have also been used to create single images which after a certain degree of de-focussing of the human eyes can suddenly reveal a three dimensional object to the eyes which was initially hidden within a seemingly random pattern.

A yet further alternative technique which is particularly adapted to the viewing of film in three dimensions involves the capture on film of a scene using a specially adapted lens assembly on the camera which splits the light from the scene impinging on the camera into two separate light fields each marginally spaced apart and either polarizes or filters the light of one or both fields before capturing the light fields on the recording medium. Three dimensional or stereoscopic viewing of this film is subsequently achieved by the wearing of stereoscopic viewing spectacles containing the relevant filters or polarising lenses to provide different images to each eye of the wearer. The simple novelty spectacles having red and green acetate filters in place of lenses are a good example of the simplest type of stereoscopic spectacles.

Although films were produced in the 1980s incorporating stereoscopy, the filtering or polarisation of the light during filming necessarily resulted in the reduction in quality of the light impinging on the film, and while the three dimensional effect was initially very appealing to the observer the viewing pleasure was limited to only short periods of time on account of both the high number of artefacts seen by the viewer wearing the stereoscopic spectacles and also the cheap nature of such spectacles, which were often disposable. Indeed such spectacles are generally useless for the stereoscopic viewing of a pair of adjacent images because their utility derives from the polarised or filtered nature of the images which are ideally superimposed, the filters or polarising lenses being used to present only certain portions of the image to a particular eye. In the case of adjacently disposed stereoscopic images, it is preferable for stereoscopic viewing spectacles to comprise a means of preventing a particular eye from seeing one or other of the adjacently disposed images, at least if the user is not to forcibly constrain his eyes to focus on only a single image which can be difficult to maintain for any significant period of time and furthermore can induce headaches in some people.

Accordingly, U.S. Pat. No. 5,943,165 to Huang describes a head mountable stereoscopic viewer having first and second mirror assemblies which are disposed on either side of the viewer and proximate each eye of the wearer. Each mirror assembly is comprised of a pair of mirrors in substantially parallel relationship and arranged to function as a simple periscope in that the first mirror receives light in a roughly horizontal direction from a first image which is reflected vertically downwardly or upwardly onto the second mirror which then reflects that light again roughly horizontally towards the particular eye with which the first or second mirror assembly is adjacent.

In the patent, the first mirror assembly is disposed substantially beneath the left eye and the second assembly is disposed substantially above the right eye so that in use, the left eye receives a predominance of light from he lower of two stereoscopic images disposed adjacently above one another, and the right eye receives a predominance of light from the upper image. It will be appreciated that the field of view provided by such stereoscopic viewing apparatus is crucial to the rapid appreciation by the wearer of the three dimensional effect as only when each respective eye focuses on one of the images is the effect readily appreciated. In this regard, the viewer is provided with a shutter mechanism including a tiltable screen disposed at least partially in front of one of the light receiving mirrors of either mirror assembly, and furthermore both mirror assemblies are mounted on a tiltable band which can be moved up or down relative to the headband by which the viewer is secured to the head of a wearer.

In use, the viewer is positioned on the head of a wearer who firstly moves the tiltable band so that his eyes are behind the respective mirror assemblies. At this stage, it is likely that the field of view is such that both eyes can view both the stereoscopic images. The wearer then adjusts the shutter to prevent light from one or other of the images from reaching one or other of his eyes, and in this regard further field of view adjustments can be made to one of the mirrors of one assembly by turning a knob to cause tilting of the mirror over a range of about ±4° from the horizontal. Hence, together with the tiltably adjustable nature or the mirror assemblies as a unit, an effective combined adjustment can be achieved which both precludes the viewing of one redundant image by one eye, and the viewing of the other redundant image by the other eye, and thus the stereoscopic effect can be rapidly obtained.

A fundamental disadvantage of the device disclosed by this U.S. patent is the bulky nature of the device which is required to be head mounted, and although provision is made for wearers who require conventional spectacles by allowing sufficient space between the eyes and the mirror assemblies, the device is nevertheless cumbersome and complex to adjust quickly with the minimum of instruction or tuition.

An alternative device is described in U.S. Pat. No. 5,114,840 to Trumbull and others which is in the style of conventional spectacles having a pair of lens assemblies which can be displaced relative to each other to account for different interocular distances of wearers. In one embodiment of the device, each of the lens assemblies include a pair of spaced apart mirrors inclined at 45° to the horizontal and disanamorphic lenses which can expand a vertically or horizontally compressed image viewed on a screen.

Although this device is clearly described as being suitable for viewing stereoscopic images, the manner in which the device ensures that the eyes of the wearer receive one of the two images being viewed involves the independent pivoting of each lens assembly proximate each respective eye and this renders the device cumbersome and complex as an adjustment mechanism is required for each lens assembly. Furthermore this does not eliminate the redundant images but merely renders one of the two images seen by each eye more prominent than the other, and therefore although expansion of the compressed adjacent images which may appear for example on a TV screen can be achieved, the stereoscopic viewing of such images by a wearer still requires effort on the part of said wearer.

This U.S. patent also describes the use of rack and pinion means coupled to the respective lens assemblies to allow for simultaneous displacement of said assemblies towards and away from each other to account for the interocular distance of a wearer when the device Is positioned on his face.

An object of the present invention is to provide a stereoscopic viewing device which is both simple to operate and inexpensive to manufacture and is furthermore lightweight and comfortable to wear or use for extended periods.

It is a further object of the invention to provide a stereoscopic viewing device having apertures adjacent each eye of a user in use through which a pair of substantially adjacent stereoscopic images may be viewed by respective eyes and which allows for adjustment of the fields of view seen through said apertures simultaneously.

According to a first aspect of the present invention there is provided a stereoscopic viewing device comprising a body having a first inner pair of apertures spaced apart by a distance equivalent to the common interocular distance of a human and adapted to be disposed adjacent the eyes of a wearer and a second outer pair of apertures in the front of the body offset in opposite directions from the inner apertures by similar distances, said body including a pair of mirror assemblies disposed between said inner and outer apertures, each mirror assembly including a pair of mirrors arranged in periscope manner being spaced apart and substantially parallel so that light entering through the outer apertures and impinging on the first mirrors of each assembly is reflected onto the second mirror before being again reflected through the inner aperture, the inclination of at least one of the mirrors of each assembly being adjustable with respect to the alternate mirror of that assembly to adjust the field of view seen through the said aperture characterised in that an adjustment mechanism is incorporated into the body which constrains the adjustable mirror of one assembly to move by an identical angle but in opposite direction to the adjustable mirror of the alternate assembly.

Preferably, the adjustment mechanism includes a mechanical linkage between the respective adjustable mirrors or each mirror assembly and an adjustment wheel, the rotation of which causes simultaneous but opposite angular movements of said respective mirrors.

Preferably the body comprises a plurality of components including left and right casings in which said apertures are provided and which include said mirror assemblies.

Preferably, the body also incorporates means which allow for adjustment of the spacing of the left and right casings, said means causing simultaneous and identical displacement of said casings but in opposite directions depending on direction of motion of adjustment means to allow for adjustment of the interocular distance of a particular wearer.

It is to be understood that by use of the word “identical” herein, as it relates to both the motion of the mirrors and the left and right casings, the applicant intends to cover slight variations in the motion of the mirrors and the casings, so that if such move by approximately the same amounts in different directions, then this is to be considered as falling within the scope of this application.

Preferably the means which permit the adjustment of the casing spacing and thus the interocular distance incorporates a rack and pinion type mechanism.

Preferably said means allowing for adjustment of the casing spacing is an integral part or the first adjustment mechanism which causes rotation of the mirrors, and further preferably the rotation or the first adjustment mechanism ideally causes said mirrors to rotate whereas an axial separation or convergence thereof causes the separate casings to separate or converge.

Alternatively, a simple adjustment wheel is provided externally of the body which communicates with the pinion of the rack and pinion mechanism and thus allows a wearer to easily adjust said interocular spacing.

Preferably a pair of limbs are connected to the body of the device to enable same to be positioned on the face of a wearer in the style of spectacles.

Preferably, the limbs are extensible, for example telescopic or having provided therein slidable and ratcheted portions, to allow for the device to be disposed in front of conventional spectacles worn by a user of said device.

Most preferably the limbs are detachable from the body of the device to allow for replacement with differently sized limbs.

Preferably a single limb is attached to the body of said device to enable same to be used in the style of opera glasses.

Further preferably the left and right casings are separated by a stationary bridge portion adapted to sit on the bridge of the nose of a wearer.

The advantages and effects of the invention will be better understood from the following specific description which is provided by way of example with reference to the accompanying drawings wherein:

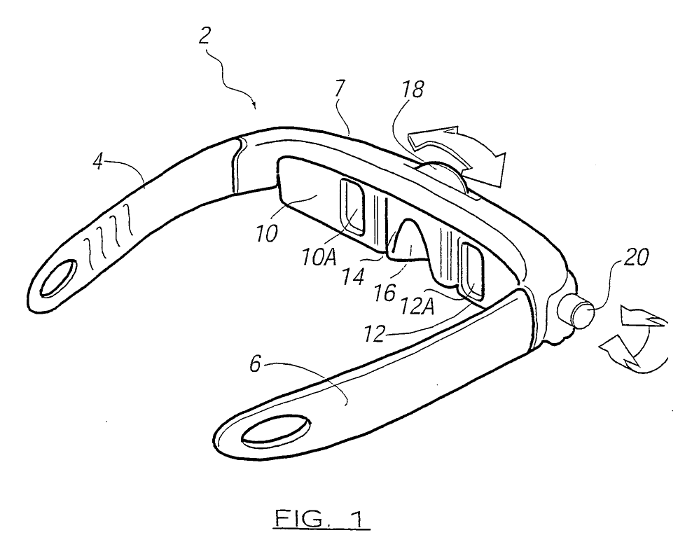

FIG. 1 shows a perspective view of a pair of stereoscopic viewing spectacles according to the invention.

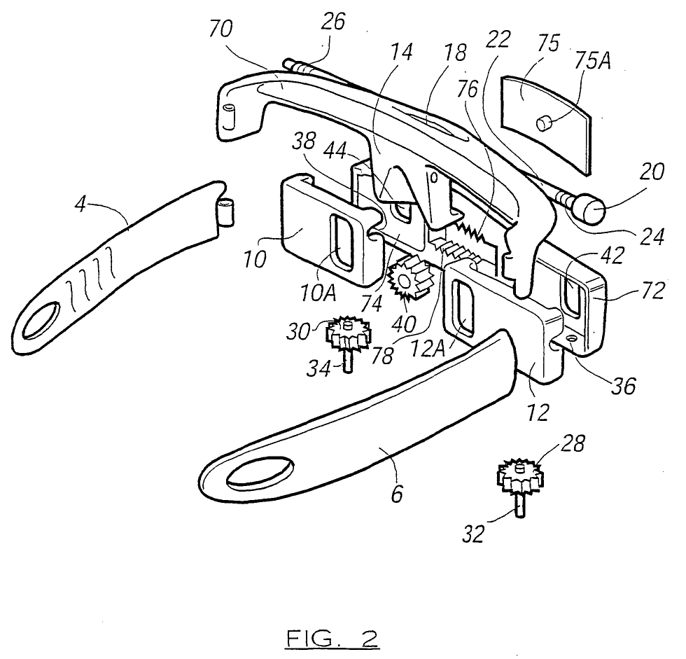

FIG. 2 shows an exploded perspective view of the spectacles of FIG. 1

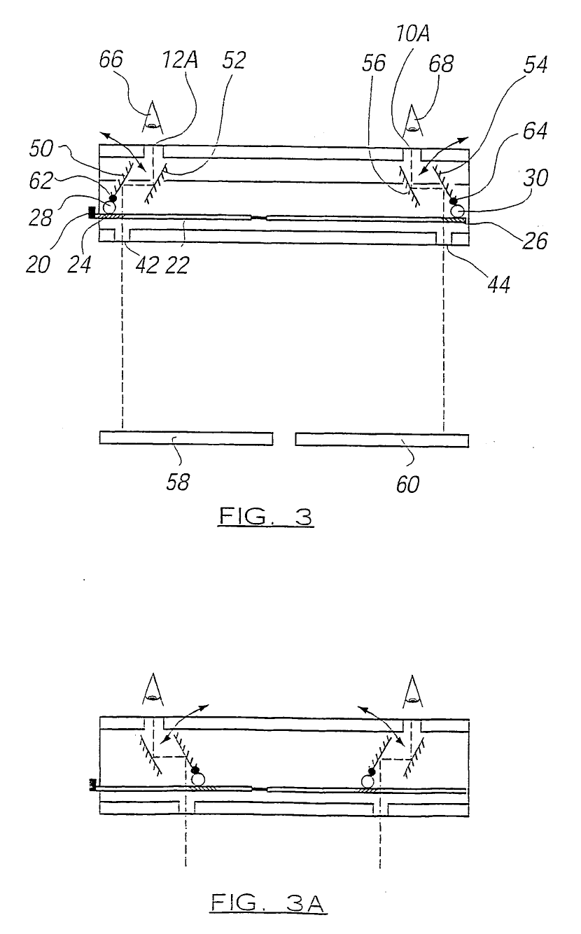

FIG. 3 shows schematically the function of the mirror assemblies incorporated within the spectacles of FIGS. 1 and 2,

FIG. 3A provides a further schematic representation of the function of the mirror assemblies, in particular how they may be differently orientated from those shown in FIG. 3, and

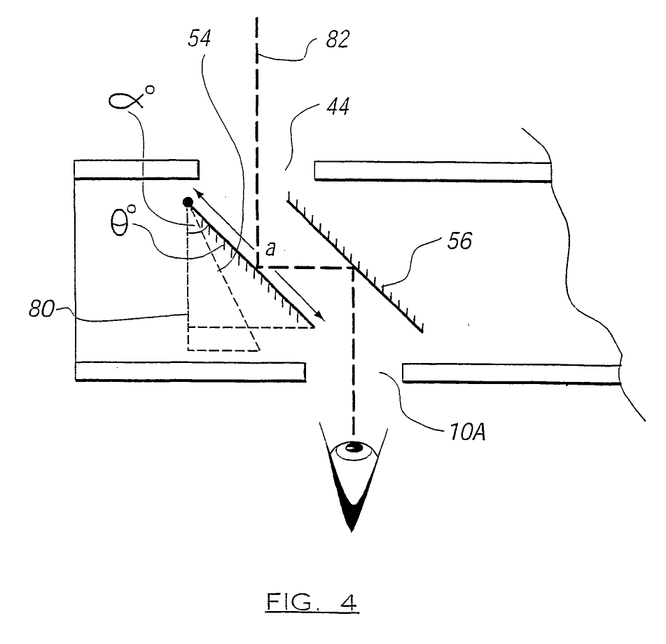

FIG. 4 shows an enlarged schematic view of the left eye portion of the device of FIG. 3.

Referring firstly to FIG. 1 there are shown stereoscopic viewing spectacles 2 having limbs 4, 6, adapted to springingly clamp opposite sides of the head of a wearer to secure the spectacles to the face of said wearer and which are connected to a body indicated generally at 7 having a left eye casing 10 separated from a right eye casing 12 by a bridge portion 14. Said bridge portion has a recess 16 which is adapted to receive the bridge of the nose of a wearer in use as is conventional for spectacles and the casings 10, 12 have apertures 10A, 12A therein through which are in use ideally disposed in front of the eyes of a wearer.

Additionally, the body 7 is provided with adjustment wheels 18, 20 which rotate about mutually perpendicular axes and which one the one hand cause simultaneous adjustment of mirror assemblies provided within the left and right casings 10, 12 and on the other hand cause simultaneous displacement of the said casings toward and away from each other, as is more clearly explained with reference to FIG. 2.

It can further be seen from FIG. 2 that the body referenced as 7 in FIG. 1 is comprised or a number of different component parts. In particular a main body component 70 is provided of which the bridge portion 14 forms an integral part and to which limbs 4, 6 may be detachably connected. A pair of caps 72, 74 provided with a pair of apertures 42, 44 which are in use disposed outside apertures 12A, 10A respectively. Each of said caps 72, 74 is provided with racks of teeth 76, 78 disposed opposite one another. The two caps 77, 74 are separate from one another and are caused to move apart or together by virtue of the engagement of the teeth in said racks with a pinion sprocket 40 which is caused to rotate by adjustment wheel 18.

Additionally, adjustment wheel 20 is disposed at one end of a bolt 22 provided with oppositely orientated worm gears 24, 26 adjacent the wheel 20 and the alternate free end of the bolt. Said worm gears engage with sprockets 28, 30 having shanks 32, 34 the free ends of which are received in recesses 36, 38 provided in the body portion 8. Said sprockets 28, 30 in turn engage with sprockets provided on one of the mirrors in each mirror assembly disposed within the casings 10, 12 so that the rotation of the adjustment wheel 20 causes simultaneous and opposite rotation of the said one mirror in each assembly.

It will be appreciated that the mirror assemblies must move together with the casings 10, 12 and the caps 74, 72 respectively to which said casings are rigidly connected between the bridge portion 14 of the main body component 70 and its extremities as the interocular distance is adjusted to enable the device, to function correctly. In this regard the bolt 22 is actually comprised of two sections slidingly coupled to one another in the centre which ensures that in rotation each section moves simultaneously in the same direction but the bolt can extend or reduce in length as the interocular distance is adjusted. Many types of connection for the section are possible to ensure this operation. All the various components of the body 7 are secured together by means of a cover 75 having a protrusion 73A which is received in a suitable recess provided in the front of the bridge portion 14.

Indeed, on account of this facility for the two parts which constitute the bolt 22 to separate without allowing for relative rotation therebetween (thus ensuring that the rotation of the mirrors in each casino is identical but in opposite direction), and in the light of the additional feature that the two parts of the bolt must necessarily be rotationally mounted in each of the left and right casings which are to be separable, it is foreseen by the applicant that it may be possible to dispense with the adjustment wheel 18 and simply provide a second adjustment wheel 20 on the alternate side of the bolt 22. In this manner, it is possible for the bolt to be used both to adjust the inclinations of the mirrors in the mirror assemblies in each casing and to adjust the interocular distance of the casings simply by having the wearer grip the two adjustment wheels 20 and apply a lateral push or pull to move the said casings in the desired direction, while simultaneously rotating the bolt to achieve the apparent superimposition of the images being viewed which is required to make a stereo or 3D image appear to the wearer. The rack and pinion mechanism ensures that the displacement of each casing is identical, although they move in opposite directions.

The ability for the wearer to simultaneously adjust both the fields of view seen in each eye by rotating the bolt and the interocular spacing by pulling the component parts of the said bolt apart or pushing them together is an important feature of the invention.

The mirror assemblies shown schematically in FIG. 3 demonstrate the worming of the invention. In particular, a pair of substantially parallel mirrors 50, 52 and 54, 56 is included in each assembly and mounted within either the caps 72, 74 or the casings 10, 12 (see FIG. 2) in with their reflective faces vertical and substantially perpendicular to the plane of viewing of a stereoscopic image pair 58, 60. It is to be mentioned that this stereoscopic image pair may be displayed on any media such as photographic film, paper, cathode ray tube, or computer screen or by projection of images onto a screen, and the images may be stationary or animated as a film, cartoon or computer game so that a viewer of same can view same three dimensionally when wearing the spectacles.

Of course, the mirror assemblies may be reversed as shown schematically in FIG. 3A. In both FIGS. 3 and 3A the objective mirror is shown as moving, but it is to be understood that either or both of the mirrors in one mirror assembly can move to achieve the perceived image displacement.

The interaction of the worm gears 24, 26 provided at opposite ends of the bolt and the sprockets 28, 30 can be seen, and furthermore said sprockets 28, 30 engage further sprockets 62, 64 provided atop the pivotally mounted mirrors 50, 54 in each assembly. Of course it is to be mentioned that the sprockets 62, 64 may be dispensed with, and the mirrors 50, 54 may be simply mounted with an edge in the shanks 32, 34 of said sprockets.

The relative inclination of one mirror with respect to another in each mirror assembly can be simultaneously changed and thus the field of view delivered to each eye of the wearer can be changed. As the separation between the images is constant and only the distance of the wearer from said images is likely to change, the field of view need only be adjusted once whereafter the three dimensional image should appear to the wearer rapidly after elimination from the field of view of the unwanted images, i.e. the image 58 seen by the left eye 68 and the image 60 seen by the right eye 66 (where left and right are defined in terms of FIGS. 1 and 2). Of course, the spectacles may be used to view images of varying size and separation.

The advantage of moving both mirrors simultaneously arises from the adjustment of the mirrors required to permit a wearer to see the three dimensional effect brought about by stereoscopy.

Initially, the spectacles are donned by a wearer and the mirrors on each side are ideally set to be exactly parallel. Depending on the distance of the wearer from the images, it is most likely that the field of view provided by the spectacles will be sufficient for each eye of the wearer to perceive both images 58, 60. It is however not imperative to ‘zero’ the mirrors and this is merely to make the viewing of a three dimensional image simpler for first time users.

The idea of providing mirrors in stereoscopic spectacles is that by moving a mirror of one mirror assembly, one of the pair of images seen by one eye can be made to move as the mirror moves into overlapping and ultimately superimposed relationship with one of the two perceived images seen by the alternate eye. At this stage, three images can be perceived by the wearer, and the central one of these three images appears immediately in three dimensions to said wearer.

Again, depending on the relative separation of the wearer from the image plane, the angular displacement of a single mirror (as proposed in U.S. Pat. No. 3,943,165) to achieve the superimposition of one of the pair of image seen by one eye onto one of the pair of images seen by another eye can be significant especially where the images and/or their separation are large, and indeed can severely, reduce the amount of light reflected to the particular eye adjacent that mirror being rotated. For example, in the instance where the mirror assemblies have a pair of mirrors parallel with one another but inclined at 45° to the line of sight as broadly represented in FIG. 4, the amount of light falling on the mirror 54 through the outer aperture 44 of the spectacles is a function of the length of the mirror 54 ‘a’, which forms the hypotenuse of a right angled triangle 80 and the angle said mirror is inclined to the line of sight 89, specifically a distance of a.sin α. As the mirror 54 is rotated (clockwise in the Figure) through a small angle θ°, the reduction in a.sin α is minimal but increases significantly as θ° approaches α, whereat the light falling on the mirror surface is reduced to zero. Hence as the amount of light falling on a particular mirror reduces significantly as the angle through which the mirror is rotated increases to bring the relevant perceived images into superimposed relationship, it is much better to move both mirrors 50, 54 simultaneously and by the same amount to bring the relevant perceived images into superimposed relationship without significantly reducing the light being reflected by said mirrors to the eyes.

As the above adjustment is critical to the invention, further explanation is merited. It is to be noted that the distance of a.sin α effectively represents the scope of the field of view. As this distance reduces on account of the rotation of the mirror, not only does the field of view change as the surface of the mirror is turned through θ°, the scope of the field (and thus the amount of light falling on the mirror) of view also reduces. It is this effect which limits the utility of the prior art spectacles in which only a single mirror is rotateable because in circumstances where the image separation or the size of the images is large, the single mirror is required to be rotated through a large angle to bring the two relevant perceived images into superposition. This results in a significant reduction in the scope of the field of view which potentially limits the perception of the three dimensional stereoscopic image.

In the present invention, the fact that both mirrors move allows a much greater variety of image sizes and separations to be viewed stereoscopically in three dimensions as the reduction in mirror rotation required maximises the scope of the field of view perceivable through each aperture adjacent the eyes of a wearer the same and additionally great enough to ensure that the stereoscopic effect is achievable.

It is additionally to be mentioned that the spectacles described herein may be adapted for viewing a left and right stereoscopic image pair regardless of the particular order in which the two images are physically positioned in front of the wearer. In order for stereoscopy to work successfully, it is necessary that the physical order of the images in which they are laid down, printed or otherwise positioned in front of the wearer is appropriate for the particular eye which is ultimately to view the image. For instance, as there are left and right eyes, so there must be an image taken to the left of an object and an image taken from the right of the same object which must be seen by the left and right eyes simultaneously and exclusively if the wearer is to appreciate a “stereo” or 3D image.

It is yet further worth mentioning that the interocular adjustment is also necessary and useful to assist the wearer of the spectacles keep an image in view when the mirrors are adjusted. The greater the mirror movement, the greater the required adjustment of the interocular spacing is likely to be. The interocular adjustment can also be used to optimise the field or view and mask the redundant images.

Although the spectacles of the invention may be conventionally used to view a stereo image pair consisting of two images arranged side by side with the first image corresponding to that which would be seen by the left eye and the second image disposed to the right of the first and being that image which would normally be seen by the right eye, it is possible to use the spectacles to allow a wearer to achieve stereoscopic effect when the two images are reversed, i.e. the conventional left image is disposed on the right side of the conventional right image. It will be appreciated by those skilled in the art that the extent of movement of which the moving mirrors in the mirror assemblies are capable may need to be increased to achieve this.

The applicant foresees that mirror assemblies can be provided in which both mirrors on each side are rotated and possibly simultaneously displaced relative to one another, and such are to be considered as falling within the scope of this application.

1. A stereoscopic viewing device (2) comprising a body (7) having a first inner pair of apertures (10A, 12A) spaced apart by a distance equivalent to the common interocular distance of a human and adapted to be disposed adjacent the eyes of a wearer and a second outer pair of apertures (44, 42) in the front of the body offset in opposite directions from said inner apertures by similar distances, said body including a pair of mirror assemblies (54, 56 and 50, 52) disposed between said inner and outer apertures, each mirror assembly including a pair of mirrors arranged in periscope manner being spaced apart and substantially parallel so that light entering through the outer apertures and impinging on the first mirrors (54, 50) of each assembly is reflected onto the second mirror (56, 52) before being again reflected through the inner aperture, the inclination of at least one of the mirrors of each assembly being adjustable with respect to the alternate mirror of that assembly to adjust the field of view seen through the said aperture characterised in that an adjustment mechanism (20, 24, 26, 28, 30) is incorporated into the body which constrains the adjustable mirror (50) of one assembly to move by an identical angle but in opposite direction to the adjustable mirror (54) of the alternate assembly.

2. A device according to claim 1 characterised in that the adjustment mechanism includes a mechanical linkage (24, 26, 28, 30) between the respective adjustable mirrors (54, 50) of each mirror assembly and an adjustment wheel (20), the rotation of which causes simultaneous but opposite angular movements of said respective mirrors.

3. A device according to any preceding claim characterised in that the body (7) comprises a plurality of components including left and right casings (74, 72) in which said apertures are provided and which include said mirror assemblies (54, 56, 50, 52).

4. A device according to claim 3 characterised by means (18, 40, 76, 78) permitting adjustment of the spacing of the left and right casings (74, 72) which causes simultaneous and identical displacement of said casings but in opposite directions depending on direction of motion of said means to allow for adjustment of the interocular distance of a particular wearer.

5. A device according to claim 4 characterised in that the means (18, 40, 76, 78) used for adjusting interocular distance included in the device incorporates a rack and pinion type (40, 76, 78) mechanism.

6. A device according to claim 4 or 5 characterised in that said means allowing for adjustment of the casing spacing is an integral part of the first, adjustment mechanism (20, 24, 26, 23, 30) which causes rotation of the mirrors (50, 54).

7. A device according to claim 6 characterised in that the first adjustment mechanism (20, 24, 26, 28, 30) is comprised of two parts which are axially linked so as to be capable of being separated from one another without permitting any relative rotation therebetween, each of said parts being rotatably mounted in the left and right casings (10, 12) respectively such that when the two parts of the adjustment mechanism are separated from one another the casing spacing is altered as desired by the wearer.

8. A device according to claim 5 characterised in a simple adjustment wheel (18) is provided with at least a portion thereof external to the body (7) which communicates with the pinion 40 of the rack and pinion mechanism.

9. A device according to any preceding claim characterised in that a pair of (4, 6) limbs are connected to the body (7) of the device to enable same to be positioned on the face of a wearer in the style of spectacles.

10. A device according to claim 9 characterised in that the limbs (4, 6) are extensible, for example telescopic or having provided therein slidable and ratcheted portions, to allow for the device to be disposed in front of conventional spectacles worn by a user of said device.

11. A device according to claim 9 or 10 characterised in that the limbs (4, 6) are detachable from the body (7) of the device to allow for replacement with differently sized limbs.

12. A device according to any of claims 9-11 characterised in that a single limb is attached to the body of said device to enable same to be used in the style of opera glasses.

13. A device according to any preceding claim characterised in that the left and right casings (74, 72) are separated by a stationary bridge portion (14) adapted to sit on the bridge of the nose of a wearer.
